(19) United States
(12) Patent Application Publication
(10) Pub. No.: US 2008/0015284 A1
(43) Pub. Date: Jan. 17, 2008

(54) Electrically-Conducting Polymers, a Method for Preparing Electrically-Conducting Polymers, and a Method for Controlling Electrical Conductivity of Polymers

(75) Inventors: Mukerrem Cakmak, Monroe Falls, OH (US); Yuma Konishi, Tokyo (JP)

Correspondence Address: ROETZEL AND ANDRESS, 222 SOUTH MAIN STREET, AKRON, OH, 44308, US

(73) Assignee: THE UNIVERSITY OF AKRON, Akron, OH (US)

(21) Appl. No.: 10/566,339

(22) PCT Filed: Jul. 29, 2004
(86) PCT No.: PCT/US04/24527

§ 371 Date: Sep. 25, 2007

Related U.S. Application Data
(60) Provisional application No. 60/490,871, filed on Jul. 29, 2003.

(51) Int. Cl. C08K 3/04; H01B 1/18; H01B 1/24

(52) U.S. Cl. 524/1; 252/500; 252/502

(57) ABSTRACT

A method for controlling electrical conductivity of a polymeric composition and a polymeric composition including a polymeric resin, a conductive filler and an effective amount of a dispersion-control agent that promotes generally-uniform arrangement of the conductive filler throughout the polymeric composition. The polymeric composition is substantially devoid of polycyclic aromatic compounds.

### RELATED APPLICATIONS

This application claims priority to a provisional U.S. application, Ser. No. 60/490,871, filed Jul. 29, 2003, entitled, CONTROLLER ELECTRICAL CONDUCTIVITY IN POLYMERS THROUGH THE USE OF CONDUCTIVE AND NON-CONDUCTIVE NANO AND MICROPARTICLES.

### FIELD OF THE INVENTION

The present invention pertains generally to polymeric materials that conduct electricity and, more particularly, to polymeric materials that have an electrical conductivity that can be controlled over a range of conductive-filler concentration.

### BACKGROUND OF THE INVENTION

This invention relates to a method for controlling the electrical conductivity of normally electrically-insulating polymeric materials. More particularly, this invention relates to the use of conductive and non-conductive nano- and micro-particles to reduce the carbon black (CB) concentration and/or other conductive particles including carbon nanotubes and chemicals' concentration necessary to reach the percolation threshold of the polymeric composition.

Conventional polymeric materials used to fabricate packaging typically insulate the package contents from an external electrically-conductive path. For applications such as packaging for electrical and semiconductor components; electromagnetic radiation shielding for satellite and space vehicle purposes; heart pads that form electrodes for electrocardiograms; and the like, there is a need to permit the dissipation of electrostatic energy that can accumulate over time.

Early attempts to provide polymeric products with this electrostatic discharge (“ESD”) property have required the blending of an electrically-conductive filler, such as carbon-black particles, into the polymeric resin chosen for the particular product. During the blending process the carbon black particles are randomly dispersed within the polymeric resin. The random dispersion of carbon black requires a suitably large carbon black concentration to ensure that an electrically-conductive path extends entirely through the polymeric product formed from the blended polymeric resin.

Applications employing recently-developed technologies require polymeric materials having a precise electrical conductivity within a small/narrow intermediate range of conductivities. However, the electrical conductivity of polymeric materials within such an intermediate range of conductivities varies sharply with carbon-black concentration, making precise control of the electrical conductivity difficult.

As the minimum electronic-device sizes continue to grow smaller, the requirements of polymeric materials for packaging and the other applications mentioned above become more stringent. In addition to precise control of electrical conductivity, permissible concentrations of electrically-conductive components, such as carbon black, that can escape the polymeric product and damage an electronic device become smaller. Minimizing the carbon-black concentration reduces the likelihood that carbon black will escape the polymeric product and corrupt a nearby electronic device.

To minimize the carbon-black concentration required to establish electrical conductivity in a polymeric product, polycyclic aromatic compounds have been incorporated into the composition of a polymeric resin and a conductive filler. It is believed that the polycyclic aromatic compound affects the electrical conductivity of the composite in two ways: by increasing the number of interparticle contacts and by decreasing the resistance to the electron transfer between the conductive particles. Although polycyclic aromatic compounds can affect the electrical conductivity of the resulting polymeric composite, polycyclic aromatic compounds are often expensive and toxic, requiring additional safeguards to be in place during synthesis. Further, polycyclic aromatic compounds often include metallic components that can also damage sensitive electronic devices.

Conventional polymer compositions known in the art include those disclosed in U.S. Pat. No. 5,298,194 to Carter et al. The '194 patent discloses polymer particles and metal particles that are blended and then subjected to head and/or pressure to provide an electrically-conductive polymer composition. It is explained that this composition may be used as an adhesive composition.

Similarly, U.S. Pat. No. 5,508,348 to Ruckenstein et al. discloses a polymer composite comprising particles of a conductive polymer uniformly distributed in a nonconductive polymer.

U.S. Pat. No. 5,567,355 to Wessling et al. discloses the formation of an intrinsically-conductive polymer. The polymer is a dispersible solid of primary particles with a specified surface area.

U.S. Pat. Nos. 6,277,303, 6,284,832, and U.S. Patent Application Publication No. 2002/0004556 all generally show a conducting polymer composition. The composition comprises a major polymer phase and a minor polymer phase, wherein the major and minor phases are immiscible. The minor phase contains a conductive filler. Although these references also disclose that the compositions may include nucleating agents such as talc, silica, mica, kaolin, and similar materials, there is no teaching of an amount of such materials to influence the conductivity of the composition, and there is also no teaching of a homogeneous blend comprising conductive and non-conductive fillers.

U.S. Patent Application Publication No. 2004/0016912 to Bandyopadhyay et al. discloses conductive thermoplastic composites and methods of making such composites. The composites of the '912 publication include a polymeric resin, a conductive filler, and an effective amount of a polycyclic aromatic compound to increase the electrical conductivity of the composite. The polycyclic aromatic compound affects the electrical conductivity of the composite by increasing the number of interparticle contacts or by decreasing the resistance to the electron transfer between the conductive particles.

### SUMMARY OF THE INVENTION

In accordance with one aspect, the present invention provides a polymeric composition comprising a polymeric resin; a conductive filler; and a dispersion-control agent that promotes generally-uniform arrangement of the conductive filler throughout the polymeric composition, wherein said polymeric composition is substantially devoid of polycyclic aromatic compounds.

In accordance with another aspect, the present invention provides a polymeric composition comprising a polymeric resin; a conductive filler; and an effective amount of a non-conducting filler to increase the electrical conductivity of the polymeric composition relative to the same composition without the addition of sub micron to nano sized particles, wherein the polymeric composition is substantially devoid of polycyclic aromatic compounds.

In accordance with another aspect, the present invention provides a polymeric composition comprising a polymeric resin; a conductive filler; and an effective amount of sub-micron to nano-sized non-conducting particles to lower the percolation threshold relative to the percolation threshold of the same polymeric composition without the sub-micron to nano-sized non-conducting particles, wherein the polymeric composition is substantially devoid of polycyclic aromatic compounds.

In accordance with yet another aspect, the present invention provides a polymeric composition comprising a polymeric resin; a conductive filler; and an effective amount of a dispersion-control agent to minimize the sensitivity of electrical conductivity of the polymeric composition to changes in a concentration of the conductive filler in a desired region of electrical conductivity, wherein the polymeric composition is substantially devoid of polycyclic aromatic compounds.

In accordance with yet another aspect, the present invention provides a method for controlling the electrical conductivity of a polymeric composition, the method comprising the steps of identifying a desired range of electrical conductivity, said range including a target electrical conductivity therein; introducing an effective amount of a dispersion-control agent to a polymeric resin to minimize the sensitivity of the electrical conductivity of the polymeric composition within the desired region of electrical conductivity; and introducing a conductive filler to the polymeric resin to provide the polymeric composition with the target electrical conductivity.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIGS. 1a-1c are schematic illustrations of different dispersion arrangements of a conductive filler in a polymer network;

FIG. 2a shows the effect of different concentrations of a dispersion-control agent on the electrical conductivity of a Nylon-6/Carbon Black composition as a function of the carbon-black concentration;

FIG. 2b shows a relationship between the electrical conductivity of Nylon-6/Carbon Black-based compositions at various carbon black concentrations;

FIGS. 3a-3c are SEM images of Nylon-6/carbon black compositions having a carbon-black concentration of 10 phr and 0 volume %, 3 volume % and 5 volume % organoclay, respectively;

FIG. 3d is a schematic representation of an SEM image to aide in the analysis of FIGS. 3a-3c;

FIGS. 4a and 4b are SEM images of Nylon-6/carbon black compositions having a carbon-black concentration of 20 phr and 0 volume % and 5 volume % organoclay, respectively;

FIG. 5a shows three illustrative histograms of the distribution of nearest neighbor length for a Nylon-6/carbon black composition having 10 phr carbon-black concentration and: 0 volume %, 3 volume % and 5 volume % organoclay concentrations, along with an enhanced SEM image of each composition;

FIG. 5b shows two illustrative histograms of the distribution of nearest neighbor length for a Nylon-6/carbon black composition having 20 phr carbon-black concentration and: 0 volume % and 5 volume % organoclay concentrations along with an enhanced SEM image of each composition;

FIG. 6 is a schematic illustration of the relation between Morishita's Index I_{δ} and dividing number q for various distribution modes of primary carbon-black aggregates;

FIG. 7 shows a relationship between Morishita's Index I_{δ} and the dividing number q for Nylon-6/carbon black compositions;

FIGS. 8a and 8b show X-ray diffraction patterns for Nylon-6 nanocomposites having: (a) 3 volume % organoclay concentration, and (b) 5 volume % concentration, where the dark layers represent the primary organoclay platelet and the gray/white areas represent the Nylon-6 matrix (all images are enhanced);

FIGS. 8c and 8d show W-ray diffraction patterns for Nylon-6/carbon black systems with a 20 phr carbon black concentration and having: (c) 3 volume % organoclay concentration, and (d) 5 volume % organoclay concentration;

FIGS. 9a and 9b show X-ray diffraction patterns and enhanced TEM images for Nylon-6/carbon black compositions with a 20 phr concentration of carbon black and: (a) 3 volume % natural-clay concentration, and (b) 3 volume % organoclay concentration;

FIG. 10a shows a TEM image of a Nylon-6/carbon black composition having a 20 phr concentration of carbon black and a 3 volume % organoclay concentration, where the dark spherical areas represent the primary carbon-black aggregate and the gray/white areas represent the Nylon-6 network;

FIG. 10b shows a TEM image of a Nylon-6/carbon black composition having a 20 phr concentration of carbon black and a 5 volume % organoclay concentration, where the dark spherical areas represent the primary carbon-black aggregate and the grey/white areas represent the Nylon-6 network;

FIGS. 11a and 11b are TEM images of a sheared Nylon-6/carbon black composition with a carbon black concentration of 20 phr and a 5 volume % of organoclay;

FIG. 11c is a TEM image of a sheared Nylon-6 composition with a 5 volume % of organoclay and without carbon black;

FIG. 12a is an enhanced TEM image of an extruded Nylon-6/carbon black composition (screw speed 200 rpm at 230° C.) having a carbon-black concentration of 20 phr and an organoclay concentration of 5 volume %, where the dark spherical areas represent the primary carbon black aggregate, the dark layers represent the primary organoclay platelet, and the gray/white areas represent the Nylon-6 matrix;

FIG. 12b is a TEM image of an extruded Nylon-6/carbon black composition (screw speed 200 rpm at 230° C.) having an organoclay concentration of 5 volume % without carbon black, where the dark spherical areas represent the primary carbon black aggregate, the dark layers represent the primary organoclay platelet, and the gray/white areas represent the Nylon-6 matrix; and

FIG. 13 is a schematic illustration of a proposed mechanism of organoclay-loading induced percolation phenomena in zero-shear viscosity of polymer melts.

### DETAILED DESCRIPTIONS OF PREFERRED AND ALTERNATE EMBODIMENTS

Percolation theory is well known to describe varying numbers of connections in a random network. Take for example, an array of holes on a substrate. Small electrically conductive particles are deposited randomly onto the substrate and can only reside in the holes formed in the substrate. Electrical conduction can occur between these particles located in adjacent holes because the conductive particles in the adjacent holes are close enough to allow the transfer of electrons, and accordingly, conduction to occur. Groups of adjacent conductive particles can accumulate into clusters, which can grow as metal particles are deposited onto the substrate. Eventually, clusters can extend from one terminus of the substrate to another terminus, forming a continuous conductive path across the substrate referred to as a spanning cluster. Conduction does not occur across the substrate until at least a minimal number of conductive particles has been deposited to span the substrate. However, the statistical probability that the first N conductive particles required to form a spanning cluster aligning themselves in such a manner almost always requires more than the minimum number of metal particles to be deposited before the probability of a spanning cluster becomes significant.

At some point during the deposition of the conductive particles there will be an sudden and dramatic increase in the electrical conduction across the substrate. The concentration of the metal particles at which this increase occurs is called the percolation threshold (“V_{f}*”), below which the substrate acts primarily as an electrical insulator.

Although percolation theory is described above using a two-dimensional substrate including an array of holes as an example, the same general principles are applicable to a three-dimensional array of holes formed in a substrate that are randomly filled with metal particles. In addition to aligning themselves across a surface of a substrate, however, the metal particles must align themselves in three dimensions through the substrate to form a spanning cluster.

It has been unexpectedly found that a polymeric composition that is substantially devoid of polycyclic aromatic compounds and comprising a polymeric network, a conductive filler, and an effective amount of a dispersion-control agent, lowers the percolation threshold V_{f}* relative to the same polymeric composition without the dispersion-control agent. The dispersion-control agent can be any material that promotes generally-uniform arrangement of the conductive-filler of the polymeric composition. Generally-uniform arrangement of the conductive filler within the polymeric composition means that the individual conductive-filler particles are dispersed in a manner to form a plurality of aggregates, and that the aggregates are then distributed in a random manner to form spanning clusters. The dispersion control agent, in combination with the polymeric resin and conductive filler, facilitates at least one of a physical interaction and a chemical interaction between the polymeric resin and the conductive filler. Preferred dispersion control agents include clay materials. Owing at least in part to the generally-uniform arrangement promoted by the dispersion-control agent, the number of conductive filler particles, and therefore the concentration of the conductive filler, required to form a spanning cluster is minimized.

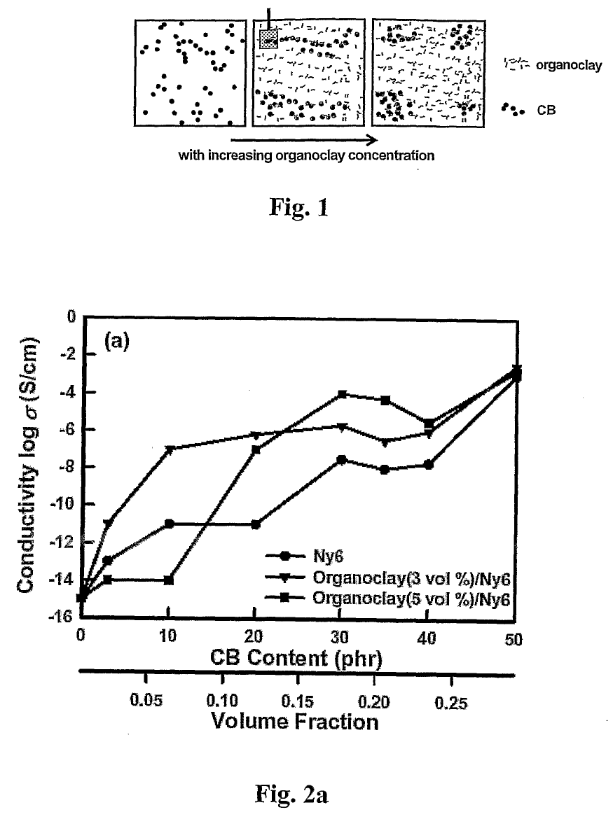

Generally-uniform arrangement of the conductive filler within the polymeric composition is shown schematically in FIGS. 1a-1c. FIG. 1a is a schematic illustration of the random dispersion of conductive-filler particles in the absence of the dispersion-control agent, said dispersion shown in FIG. 1a being referred to herein as Regular Mode dispersion. The random arrangement of conductive-filler particles in Regular Mode requires a significantly larger concentration of conductive filler to form aggregates than required with the inclusion of the dispersion-control agent. Instead of forming aggregates that are dispersed according to Regular Mode, the individual conductive-filler particles themselves are randomly dispersed within the polymeric network.

In contrast, FIG. 1b schematically illustrates an embodiment of a generally-uniform arrangement of the conductive filler facilitated by the dispersion-control agent, said generally-uniform arrangement being interchangeably referred to herein as Aggregated Mode dispersion. As mentioned above, the individual conductive-filler particles are formed into a plurality of aggregates by the dispersion-control agent, and the aggregates are then distributed in Regular Mode as a whole.

Generally-uniform arrangement, or Aggregated Mode dispersion of the conductive-filler particles can include aggregates of any size, depending at least in part on the concentration of the dispersion-control agent in the polymeric composition. For example, the aggregates of the conductive-filler particles in FIG. 1b are large aggregates relative to the aggregates shown schematically in FIG. 1c, which are small aggregates.

The dispersion control agent can be any material that, in combination with the polymeric resin and conductive filler, facilitates at least one of a physical interaction and a chemical interaction between the polymeric resin and the conductive filler. Preferred dispersion control agents include clay materials. The terms layered clay material, layered clay, layered material, clay material and clay are interchangeably used to mean any organic or inorganic material or mixtures thereof, such as a smectite clay mineral, which is in the form of a plurality of adjacent, bound layers. The layered clay comprises platelet particles and is typically swellable. Platelets and platelet particles shall mean individual or aggregate unbound layers of the clay material. These layers may be in the form of individual platelet particles, ordered or disordered small aggregates of platelet particles (tactoids), and/or small aggregates of tactoids.

Without being bound to theory, the dispersion control agent establishes an interaction between a conductive-filler particle and one reactive site on the polymeric resin. Thermodynamic affinity between the polymer network and the dispersion-control agent, also referred to herein as nanoparticles, is believed to be necessary to allow proper dispersion/exfoliation of the nanoparticles. This can be accomplished through several methods. One is to ensure the existence of strong intermolecular forces between polymer networks and the nanoparticles. The strong intermolecular forces could be polar interactions, as in the case of Nylon 6 and clay nanoparticles, or other known strong bonds. In the absence of strong intermolecular forces, the polymer networks can be modified to create this affinity between the polymer networks and the nanoparticles. For example maleic anhydrite modification of polyolefins allows them to interact with modified clay nanoparticles. In order to enhance the affinity, the nanoparticles' surface chemistry may be altered to facilitate strong interaction between the polymer networks and the nanoparticles. Once the polymer network/nanoparticle interaction is established, a partial and/or fully dispersed/exfoliated system. Incorporating the conductive filler into such a composition allows the unexpected decrease of V_{f}* and leveling off of the slope of the percolation curve in a desired range of electrical conductivities.

Although it is very difficult, if not impossible to identify the specific types of interactions between the conductive filler and the polymeric networks in multi-phase polymeric materials, the interactions are believed to be a combination of weak physical interactions, such as dipole—dipole interactions, and strong chemical interactions, such as hydrogen bonding. Regardless of the particular interactions, instead of forming a cluster at the reactive site where the first conductive-filler particle was introduced, the dispersion control agent facilitates the formation of another interaction between a subsequently-introduced conductive-filler particle and another reactive site on the polymeric resin. Thus, the dispersion control agent establishes a preference for the formation of an interaction between conductive-filler particles and available reactive sites on the polymeric resin before the formation of a cluster at a single reactive site on the polymeric resin. In this manner, the conductive-filler particles will be dispersed generally uniformly throughout the resulting polymeric composition. Generally uniform dispersion minimizes the concentration of the conductive filler required to form a spanning cluster and accordingly, thereby lowering the percolation threshold V_{f}*.

Generally-uniform arrangement of the conductive filler by the dispersion control agent of the present invention also results in a less-sudden and dramatic relationship between the electrical conductivity and conductive-filler concentration relative to that same relationship for the polymeric composition without the dispersion control agent. A curve illustrating the relationship between the electrical conductivity of a polymeric composition including the dispersion control agent versus the conductive-filler concentration will have a slope in the desired region that is less positive than the slope of the same curve for the polymeric composition without the dispersion control agent. Thus, introducing an effective amount of the dispersion control agent into the polymeric composition allows precise control of the electrical conductivity in a desired range.

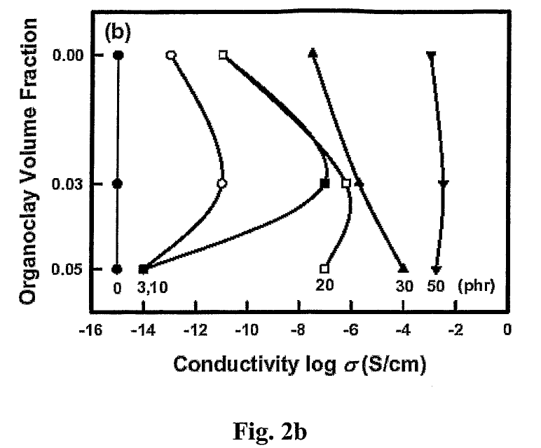

The appropriate concentration of the dispersion-control agent to include in the polymeric composition is determined based at least in part on the desired electrical conductivity to be achieved, and the allowable deviation from that electrical conductivity. FIG. 2a is a plot of the electrical conductivity versus the concentration of the conductive filler for a polymeric composition comprising Nylon-6 (“Ny6”) as the polymeric resin, carbon black (“CB”) as the conductive filler, and Montmorillonite (“organoclay”) as the dispersion-control agent. As can be seen from FIG. 2a, the curve for the polymeric composition without the dispersion-control agent (the “Ny6/CB” composition) is a stepwise curve having generally nonsloping portions and generally steep-sloping portions. Adjusting the CB concentration for the Ny6/CB composition to a value within the range of 10⁻⁷-10⁻⁶ S/cm is difficult because of the steep slope of the Ny6/CB curve within this range, making the electrical conductivity of the polymeric composition sensitive to CB concentration in this region. A small variation in CB concentration will bring about a significant change in the composition's electrical conductivity, making control of the electrical conductivity difficult.

In contrast, the curve for the polymeric composition with a 3 volume % concentration of the dispersion-control agent (the “Ny6/CB/organoclay (3 vol %)” composition) follows a generally negative inverse-exponential relationship to the CB concentration. The percolation threshold of the Ny6/CB/organoclay (3 vol %) composition occurs at a lower CB concentration than the percolation threshold of the Ny6/CB composition, and also has a less-positive slope within the electrical-conductivity range of 10⁻⁷-10⁻⁶ S/cm. Adjusting the CB concentration for the Ny6/CB composition to a value within the range of 10⁻⁷-10⁻⁶ S/cm is difficult because of the steep slope of the Ny6/CB curve within this range, making the electrical conductivity of the polymeric composition sensitive to CB concentration in this region. A small variation in CB concentration will bring about a significant change in the composition's electrical conductivity, making control of the electrical conductivity difficult.

Including organoclay in an amount of 3 volume % to the polymeric composition results in a percolation threshold lowered to about 1-3 phr CB, an increased electrical conductivity that reaches the low end of the desired-conductivity range of 10⁻⁷-10⁻⁶ S/cm at about 10 phr CB, and more-gradual slope of about 4.5*10⁻⁸ S/cm/phr CB. Accordingly, the effective amount of organoclay can be optimized to produce a polymeric composition with a desired electrical conductivity within a range of electrical conductivities while minimizing the conductive-filler concentration and the sensitivity of the electrical conductivity to changes in conductive-concentration within the range electrical conductivities.

Molded and other products fabricated from the polymer composition of the present invention exhibit minimal spatial variation in their electrical conductivity. Products formed from conventional polymer compositions typically include a significant number of locations that do not conduct electricity as well as other locations. It is believed that this spatial variation of electrical conductivity in conventional products is caused by the random ordering of the conductive filler, forming clusters in discrete locations within the polymeric composition instead of a generally uniform network of the conductive filler. In contrast, the dispersion of the conductive filler by the dispersion control agent according to the present invention results in a polymeric composition having a generally-uniform electrical conductivity throughout. Accordingly, products fabricated from this polymeric composition will have substantially the same electrical conductivity at all points on its outermost surface, regardless of the locations of where the electrical-conductivity measurements are performed.

The polymeric resin used in the composites may be selected from a wide variety of thermoplastic resins, thermoplastic elastomers, and thermoset resins, as well as combinations comprising one or more of the foregoing resins. Specific nonlimiting examples of suitable thermoplastic resins include polyacetals, polyacrylics, styrene acrylonitriles, acrylonitrile-butadiene-styrenes (ABS), high impact polystyrenes (HIPS), polyethylene vinyl acetates (EVA), polylactic acids (PLLA for example), polycarbonates, polystyrenes, polyethylenes, polyethylene oxides, polymethylmethacryalates, polyphenylene ethers, polypropylenes, polyethylene terephthalates, polybutylene terephthalates, Nylons (Nylon-6, Nylon-6/6, Nylon-6/10, Nylon-6/12, Nylon-11 or Nylon-12, for example), polyamideimides, polyarylates, polyurethanes, ethylene propylene diene rubbers (EPR), ethylene propylene diene monomers (EPDM), polyarylsulfones, polyethersulfones, polyphenylene sulfides, polyvinyl chlorides, polysulfones, polyetherimides, polytetrafluoroethylenes, fluorinated ethylene propylenes, perfluoroalkoxyethylenes, polychlorotrifluoroethylenes, polyvinylidene fluorides, polyvinyl fluorides, polyetherketones, polyether etherketones, polyether ketone ketones, liquid crystal polymers and mixtures comprising any one of the foregoing thermoplastics. Preferred thermoplastic resins include polycarbonates, polybutylene terephthalates, and mixtures comprising one or more of the foregoing resins.

Specific nonlimiting examples of blends of thermoplastic resins include acrylonitrile-butadiene-styrene/Nylon, polycarbonate/acrylonitrile-butadiene-styrene, acrylonitrile butadiene styrene/polyvinyl chloride, polyphenylene ether/polystyrene, polyphenylene ether/Nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, Nylon/elastomers, polyester/elastomers, polyethylene terephthalate/polybutylene terephthalate, acetal/elastomer, styrene-maleic anhydride/acrylonitrile-butadiene-styrene, polyether etherketone/polyethersulfone, polyether etherketone/polyetherimide polyethylene/Nylon, polyethylene/polyacetal, polyethylene oxide/polylactic acid, polymethylmethacryalate/polyvinylidene fluoride, and the like.

Specific nonlimiting examples of thermosetting resins include polyurethane, natural rubber, synthetic rubber, epoxy, phenolics, polyesters, polyphenylene ether, polyamides, silicones, and mixtures comprising any one of the foregoing thermosetting resins. Blends of thermosetting resins as well as blends of thermoplastic resins with thermosetting resins can be utilized.

Specific nonlimiting examples of conductive fillers include carbonaceous fillers such as carbon nanotubes (single-walled and multi-walled), vapor-grown carbon fibers having diameters of about 2.5 to about 500 nanometers, carbon fibers, carbon black, graphite, graphite nanoplatelet, and mixtures comprising one or more of the foregoing fillers.

Specific nonlimiting examples of the dispersion control agent include wide range of particles with at least one dimension in nanometer scale. These include clay minerals and organically modified clays, other inorganic particles of appropriate size and shape that includes ceramic nanoparticles, organic particles of appropriate particle size, specific surface area, aggregate structure, and surface chemistry.

As mentioned above, the polymeric composition of the present invention further comprises a conductive filler that provides the polymeric composition with the ability to conduct electricity. Suitable conductive fillers include solid conductive metallic fillers or inorganic fillers coated with a solid metallic filler. These solid conductive metal fillers may be an electrically conductive metal or alloy that does not melt under conditions used when incorporating them into the polymeric resin, and fabricating finished articles therefrom. Metals such as aluminum, copper, magnesium, chromium, tin, nickel, silver, iron, titanium, and mixtures comprising any one of the foregoing metals can be incorporated into the polymeric resin as solid metal particles. Physical mixtures and true alloys such as stainless steels, bronzes, and the like, can also serve as metallic constituents of the conductive filler particles herein. In addition, a few intermetallic chemical compounds such as borides, carbides, and the like, of these metals (e.g., titanium diboride) can also serve as metallic constituents of the conductive filler particles herein. Solid non-metallic, conductive filler particles such as tin-oxide, indium tin oxide, and the like may also be added to the polymeric resin. The solid metallic and non-metallic conductive fillers may exist in the form of drawn wires, tubes, nanotubes, flakes, laminates, platelets, ellipsoids, discs, and other commercially available geometries. In addition carbon based conductive particles can be used for this purpose. These include carbon blacks, carbon nanofibers, carbon nanoplatelets, carbon nanotubes with wide range of chemical and physical modifications. Metallic nanoparticles that can include nano tubes of metallic particles as well as other shaped particles.

### GENERAL EXPERIMENTAL

In addition to the general description of the present invention set forth above, a specific embodiment is described below. The specific embodiment comprises a Nylon-6 (“Ny6”) polymeric resin, carbon black (“CB”) as the conductive filler, and Montmorillonite (“organoclay”) as the dispersion control agent. The specific description that follows also includes the description of a conventional polymeric composition comprising Ny6 and CB without the dispersion control agent for comparison to illustrate the electrical property/CB dispersion relationships in products that are compression-molded from CB-filled Ny6, and CB-filled Ny6 with organoclay.

CB is a well-known organic nanoparticle, which has an approximately-spherical shape and is formed from an aggregation of individual particles having a diameter on the order of nanometers. Although CB typically includes a series of polycyclic aromatic hydrocarbons at various states of oxidation, the polymeric composition of the present invention is substantially devoid of polycyclic aromatic compounds, meaning that no appreciable amount of an polycyclic aromatic compound is added in addition to that present on the surface of the CB.

Organoclay is a layered clay mineral, inorganic compound that comprises flexible aluminosilicate-platelet layers that are approximately 200 nm in length and 1 mn in thickness with a flat surface. Organoclay has exchangeable sodium cations between its layers, and it is hydrophobic and generally incompatible with organic molecules. However, sodium cations can be exchanged with organic cations to improve affinity towards organic molecules.

Polymer matrix nanocomposites with the exfoliated silicate platelet of organoclay have mechanical and gas barrier properties that are not readily available in conventional composites. Since the silicate platelets of organoclay have polar groups, they have good affinity for polymers containing polar functional groups. This is believed to be one of the reasons that Ny6 and organoclay nanocomposites are compatible and improve physical properties due to the small interfacial tension between Ny6 and organoclay.

Chemical modification of layered silicate platelet nanoparticles (organoclay) affects intercalation, exfoliation, and nano-scale dispersion in polymer matrices such as nylon 6, and generates novel physical properties in the nanocomposites. Organoclay in nylon 6 matrix can be dispersed by two major methods: One is by in situ polymerization with mixture of ε-caprolactum and organoclay such as modified by 12-aminolauric acid or longer alkylene chain attached in amino acids as a catalyst, resulting the interlayer distances of organoclay increase significantly with the presence of ε-caprolactum during polymerization associated with positively charged amine end-groups of nylon 6 directly form ionic bonds on the negatively charged silicate platelet surface. The other is by melt blending with nylon 6 and organoclay such as modified by quaternary ammonium chloride (organic modifier) and/or it attached with hydroxyl or carboxyl groups (functional groups). The interlayer distances of organoclay increase with the diffusion/penetration of nylon 6 chains associated with mechanical shear and in amide groups of nylon 6 may be formed hydrogen bonds with the functional groups attached to the organic modifier or the amine end-groups may have physical interactions such as London (dipolar) interactions on the pristine silicate platelet surface that the interfacial tension between nylon 6/organoclay may become extremely small. However, the mechanism of nylon 6-clay (or organoclay) interactions for intercalation/exfoliation and the factors (or driving force) for organoclay nano-scale dispersion in the absence of shear flow are still unclear.

### Materials and Sample Preparation

Two commercial film grade neat nylon 6 and melt blended nylon 6 nanocomposites with 3.0 and 5.0 vol % organoclay-loading (RTP Company, USA) were used. Commercial low-structure rubber grade carbon black (CB) (Seast® G-SVH, Tokai Carbon Co., Japan: primary particle diameter: 62 nm, N₂ specific surface area: 32 m²/g, DBP oil absorption: 140 cm³/100 g) as a conductive-filler nanoparticle was used.

Neat nylon 6 and nylon 6 nanocomposites in the form of extruded pellets and as received CB in the form of fine powder were dried at 80° C. for 24 h under vacuum prior to melt blending. The melt blending was carried out by using a general internal mixer (Brabender Plasticorder, USA) for 10 min at 245° C. using 60 rpm rotation speed. Films (0.5 mm thickness) and disks (2.0 mm thickness with 25 mm diameter) were compression-molded at 250° C. for 10 min under a pressure of 20 MPa, followed by air cooling at room temperature for 5 min.

### Electrical Conductivity Measurements (ASTM D257, and D4496)

The electrical conductivity was measured in the thickness direction of the film using a Keithley 6487 picoammeter equipped with a direct-current voltage source. The voltage values ranged from about 0.001 to about 5000 V. The bulk conductivity of the films was determined as the average of four conductivity measurements, with each conductivity measurement being taken from a different location in a center region of each film.

### SEM Observations

The state of CB dispersion was observed by means of a field emission type SEM (JEOL). Specimens were freeze-fractured in liquid nitrogen. The freeze-fractured surface was coated by the Polaron high-energy silver-sputtered device under vacuum atmosphere for 1 min.

### Digital Image Analysis of SEM Photographs

Quantitative analysis of the CB dispersion was characterized by the statistical processing of the SEM photographs using the quadrate method and Morishita's distribution index: I_{δ}. The index plays an important role in the characterization of the distribution modes which is given by the formula:

I_{δ}=qδ (i)

where δ is given by the formula:

$$δ = \frac{{\sum }_{i = 1}^{q} {n}_{i} ( {n}_{i} - 1 )}{N ( N - 1 )} \qquad ( ii )$$

where q is the number of elemental parts equally divided from the total area of the SEM images; nᵢ is the number of particles in the i^{th} section; and N is the total number of particles, which is given by the formula:

$$N = {\sum }_{i = 1}^{q} {n}_{i} \qquad ( iii )$$

### Results

### Electrical Percolation Behavior

Percolation curves for the various Ny6/CB based compositions with various organoclay-loading are shown in FIG. 2a, which shows typical plots of log σ vs CB concentration at room temperature, and FIG. 2b, which shows plots of organoclay volume fraction vs log a for the respective CB concentrations. The formation of a conducting network does not require direct contact between two CB particles, but only a sufficiently-close relationship (usually in the order of nanometers) for electron tunneling to occur. The Ny6/CB composition without organoclay exhibited an electrical-conductivity increase of about three orders of magnitude by reaching a CB concentration of 30 phr (phr=CB weight per hundred parts of resin), which was determined to be the percolation threshold V_{f}*.

FIG. 2a also illustrates the percolation curves for the Ny6/CB/organoclay (3 vol %) and Ny6/CB/organoclay (5 vol %) compositions. For each of these curves, it is apparent that the percolation threshold is lower than it was for the Ny6/CB composition that did not include the organoclay. The percolation threshold shifted to 10 phr CB for 3 vol % organoclay-loading, and 20 phr CB for the 5 vol % organoclay-loaded nylon 6-CB composition.

Two novel percolation features were also observed: (i) As the volume % of organoclay was decreased, the slope of the percolation curves became more gradual, with slopes of 3 (5 vol % loading), 2.5 (3 vol % loading), and 1.5 (0 vol % loading) in the percolating regions (i.e., the regions following the percolation threshold). It is believed that this behavior is due to the strong affinity between Nylon-6 and CB. Polymer resins without such an affinity for the conductive filler may experience an increase in slope with the decrease in clay concentration. And (ii) the electrical conductivity increased with the volume % of organoclay at higher CB-concentration regions of 30, 35, and 40 phr CB, respectively.

FIG. 2b provides an overview of organoclay-loading-induced percolation phenomenon of the present invention in nylon 6-CB composites. The Ny6/CB/organoclay (3 vol %) composition exhibited the greatest electrical conductivity at low CB concentrations (<20 phr). At intermediate CB concentrations (20 phr<CB<40 phr), the electrical conductivity data of 5 vol % organoclay-loading increases and eventually exceeds the electrical conductivity of the Ny6/CB/organoclay (3 vol %) composition. At high CB concentrations (>40 phr) final stage the electrical conductivity data for all nylon 6-CB systems with various organoclay-loading become nearly linear and stable. For each of these compositions, low-structure rubber grade CB as conducting nanoparticles were chosen, which have compact primary aggregates comprising few primary particles that make it difficult for this particular CB to disperse and develop percolating-network structures by self-agglomeration without the aid of the dispersion-control agent.

### Dispersion and Distribution of CB and Organoclay

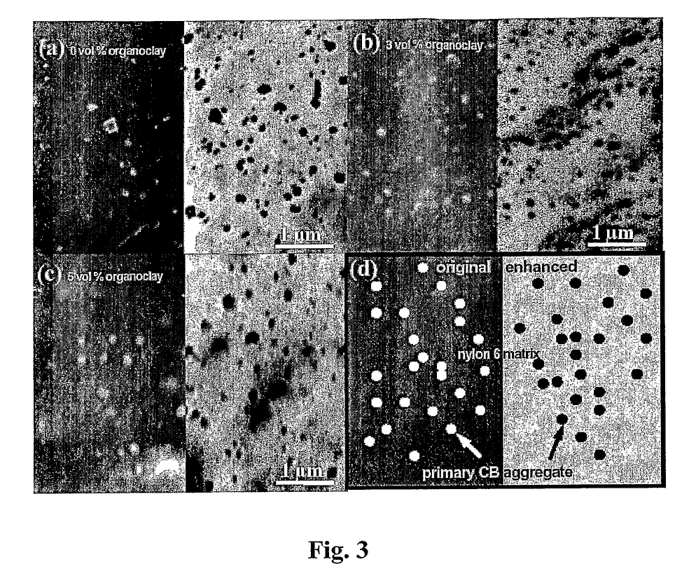

FIG. 3 shows typical SEM images of the Ny6/CB 10 phr systems with various levels of organoclay loading. In FIG. 3, the white spots in the original images (or black spots in the enhanced images) represent the primary CB aggregate and the dark areas in the original images (or the gray areas in the enhanced images) represent the nylon-6 network. For each pair of images, the left image is the original and right image is the enhanced version of the same SEM image. The schematic in FIG. 3d helps in the interpretation of the SEM images. With the variation of organoclay-loading from 0 to 3 vol % in FIG. 3a and 3b, respectively, the original CB dispersion in FIG. 3a metastasizes to “branching” and/or “chaining” morphology as shown in FIG. 3b. This observation is in accord with the fact that the Ny6/CB/organoclay (3 vol %) composition achieves percolation at about 10 phr CB, which is the percolation threshold V_{f}* shown in FIG. 2a. It was also observed that as organoclay-loading increased from 3 volume % to 5 volume %, the state of CB dispersion in the Ny6/CB/organoclay (5 vol %) composition does not resemble a percolating structure due to the fact that 10 phr CB concentration is not the percolation threshold V_{f}* for the Ny6/CB/organoclay (5 vol %) composition.

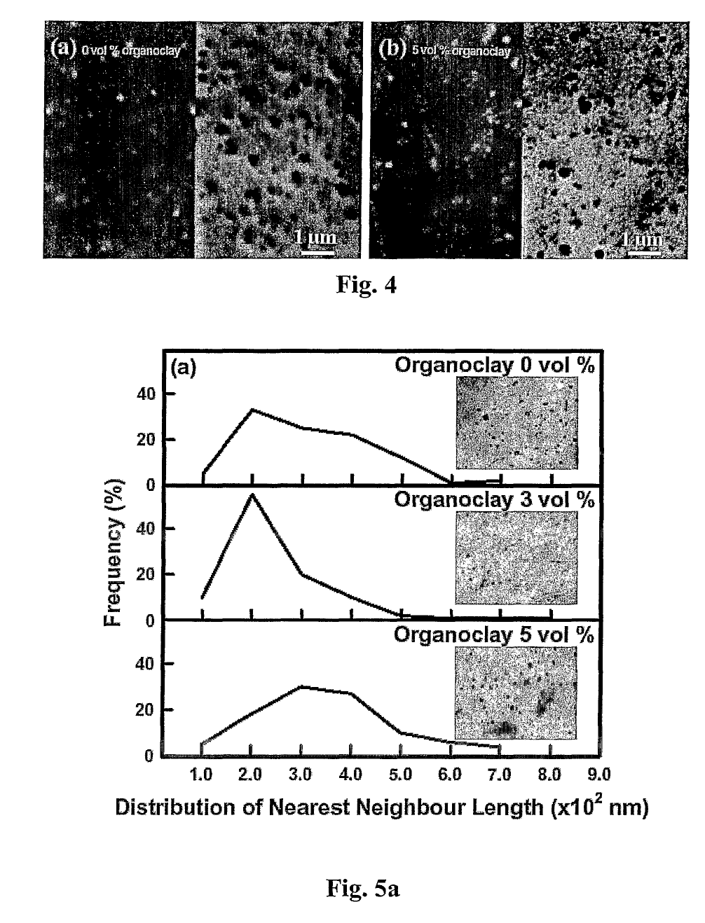

As additional support for the position in the preceding paragraph, FIG. 4 shows SEM images of a Ny6/CB-based composition with 20 phr CB concentration with the different organoclay-loading levels discussed above. A well-developed “fish-net” morphology with co-continuous CB network structure was observed in FIG. 4b, because 20 phr CB concentration is the approximate percolation threshold V_{f}* for Ny6/CB compositions having 5 vol % organoclay-loading. This is contrasted with the image shown in FIG. 4a, which exhibits relatively scattered CB aggregates morphology, which is in accord with the fact that the Ny6/CB composition without any organoclay has not achieved its percolation threshold for 20 phr CB concentration. It is hypothesized that this structural development and electrical property variation in FIGS. 2 to 4 arises from the organoclay-loading-induced advanced-percolation phenomenon. A morphological mechanism as well as the definition of advanced percolation are presented below.

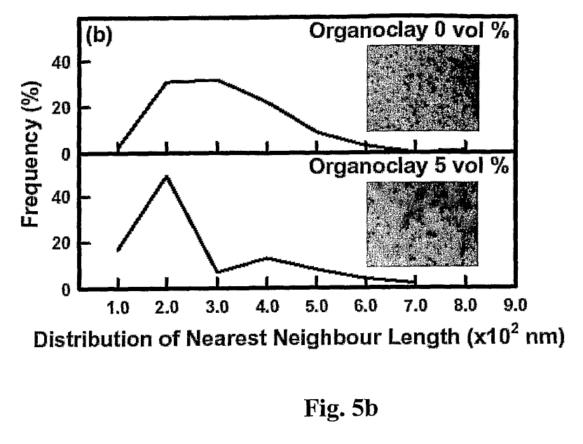

To clarify further morphological features in FIGS. 3 and 4, image analysis was conducted on all SEM images. FIG. 5 shows the histogram of the distribution of nearest neighbor length for the Ny6/CB 10 phr CB and Ny6/CB 20 phr CB compositions with various organoclay-loading levels. CB dispersion is the distribution of CB aggregates and inter-CB/CB (or inter-aggregate) distance in polymer matrices. Referring to FIG. 5, sharp peaks of the histogram appear at 200 nm for the Ny6/CB/organoclay (3 vol %) composition (FIG. 5a) and the Ny6/CB/organoclay (5 vol %) (FIG. 5b) organoclay-loading. These histogram peaks are the criteria for a percolating structure, and 200 nm is the distance, which indicates the nearest neighbor length for inter-CB/CB interactions to achieve percolation in a Ny6 polymer network. It is noted that this observation supports the conclusions drawn from FIG. 2, and is expected since 10 phr CB and 20 phr CB concentrations are the percolation thresholds V_{f}* for the Ny6/CB/organoclay (3 vol %) composition and the Ny6/CB/organoclay (5 vol %) composition, respectively.

Additional insight into the morphological features were gained from quantitative image analysis on the state of CB dispersion as characterized by utilizing the quadrate method of Morishita and Morishita's I_{δ} index, disclosed in Morishita, M. In Memoirs of the Faculty of Science Ser. E, Biology; Kyushu University: Fukota, Japan, 1959; 2, 215., Karasek, L.; Sumita, M. J. Matex Sci. 1996, 31, 281, which is incorporated in its entirety herein by reference.

According to Morishita's method, the total area of each SEM image was divided into small equal-area elementary regions, and the number of points in each region was calculated.

A primary CB aggregate, defined as a single dot in the inset enhanced SEM images in FIG. 5, is used to pattern variation of CB dispersion against to Morishita's Index I_{δ} as a function of quadrate number q, which is expressed by

$$\begin{matrix}I δ = q \cdot δ \\ with & ( i ) \\ δ = \frac{{\sum }_{i = 1}^{q} {n}_{i} ( {n}_{i} - 1 )}{N ( N - 1 )} & ( ii )\end{matrix}$$

where q is the number of elemental parts equally divided from the total area of the SEM images, nᵢ is the number of primary CB aggregate regarded as one dot in the i th section of the SEM images, and N is the total number of primary CB aggregates regarded as dots.

$$N = {\sum }_{i = 1}^{q} {n}_{i} \qquad ( iii )$$

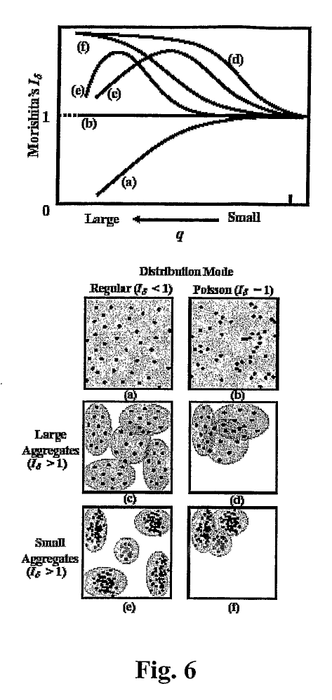

Image analysis was conducted with original programmed software (Image Analysis for Windows, version 4.10, ASAI© based on the equations 1 to 3. FIG. 6 shows a schematic that illustrates the relation between Morishita's Index I_{δ} and dividing number q for various distribution modes of primary CB aggregates.

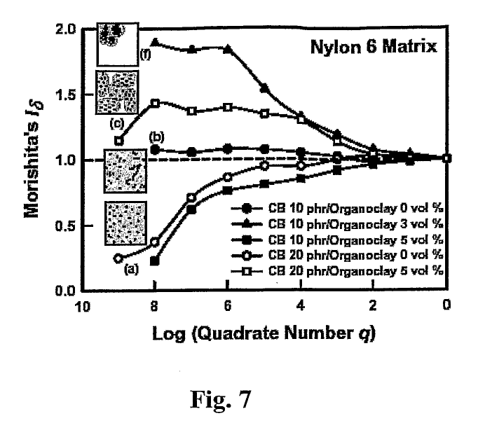

FIG. 7 shows the Morishita's Index I_{δ} v. dividing number q for the Ny6/CB composition with 10 phr CB concentration and Ny6/CB composition with 20 phr CB concentration having various organoclay-loading levels obtained from the SEM images. The following observations support FIGS. 2 to 5:

As the level of organoclay-loading increases for the Ny6/CB composition with 10 phr CB concentration, the Morishita's Index I_{δ} varies according to: I_{δ}=1 (0 vol % organoclay loading), I_{δ}>1 (3 vol % organoclay loading), and I_{δ}<1 (5 vol % organoclay loading), which corresponds to the variation of distribution mode indicated by symbols (b), (f), and (a) shown in FIG. 6, respectively. The above observation suggests that at 0 vol % organoclay-loading the distribution of CB aggregates indicates Poisson mode, which is under-scattered CB aggregate morphology. As organoclay-loading increases to 3 vol %, the distribution metastasizes to aggregated mode with small size aggregates distributed within Poisson mode as a whole. At 5 vol. % organoclay-loading, the distribution becomes regular mode.

For Ny6/CB compositions with 20 phr CB concentration, the Morishita's Index I_{δ} varies according to: I_{δ}<1 (0 vol % loading); and I_{δ}>1 (5 vol % loading), which correspond to the variation of distribution mode indicated by symbols (a) and (c) shown in FIG. 6, respectively. This observation indicates that the presence of organoclay enhances the distribution of CB aggregates from regular mode to aggregated mode with large size aggregates distributed within regular mode as a whole. Thus, CB dispersion in the Ny6 network is forced to form percolating network structures by the presence of organoclay at low organoclay-loading, whereas high organoclay-loading induces stability and regularity upon CB dispersion. It is believed that the novel electrical percolation behavior in the Ny6/CB-based compositions is due to the organoclay-loading induced advanced-percolation phenomenon.

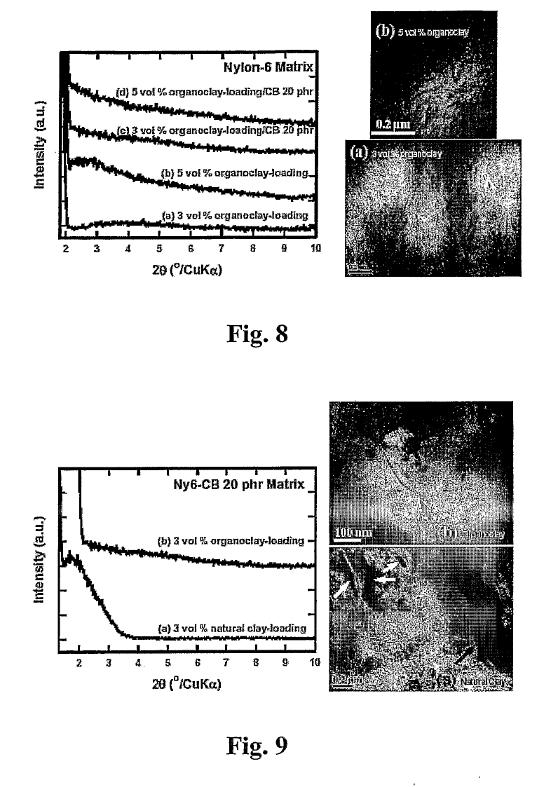

To help describe the present invention, the type of organoclay-loaded structures for various melt blended Ny6 compositions was determined. FIGS. 8a-b and 9a-b show X-ray diffraction patterns with bright-field TEM images for Ny6 nanocomposites, where the dark layers represent the primary organoclay platelet and the gray/white areas represent the Ny6 matrix (all images are enhanced). The X-ray diffraction patterns do not show any discernible intensity peak, which seems to indicate a fair degree of organoclay exfoliation and dispersion as shown in TEM images.

To further support the above observation, FIGS. 8c-d show X-ray diffraction patterns for Ny6/CB compositions with 20 phr CB concentration with varying organoclay-loading.

Despite the significant amount of CB in the Ny6 nanocomposites, the X-ray diffraction patterns lead to unexpectedly-smooth curves, or a fully exfoliated structure, indicating an extensive layer separation associated with their physical separation e.g. exfoliation. However, one can distinguish the discernible intensity peak in FIG. 9a that natural clay dispersed in nylon 6-CB 20 phr fails in exfoliation, which we can distinguish from the TEM image. This observation suggests that the driving force of advanced percolation in Ny6/CB compositions is associated with at least partially or fully exfoliated organoclay dispersion state.

### Morphology of Rigid Organic Carbon and Brittle Clay Mineral

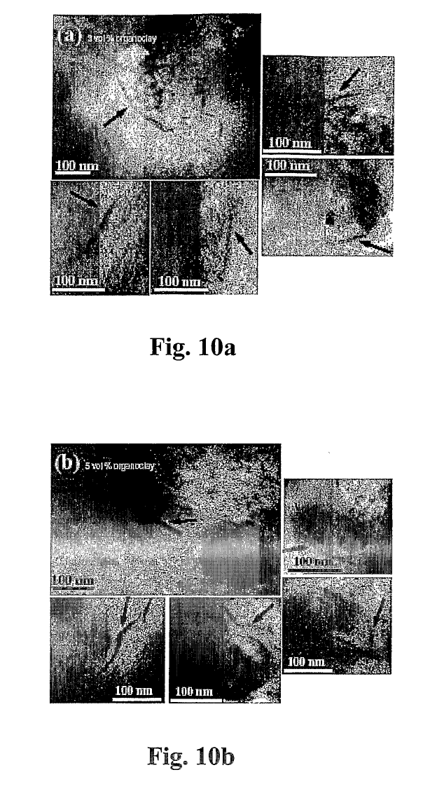

In an effort to search for evidence that may support or reject the positions addressed above, real-time morphological and selected-area high-resolution observations (×135,000) by STEM for various Ny6 nanocomposites and Ny6/CB compositions with varying organoclay-loading were conducted. The objective was to search morphological evidence, especially on the relation between rigid spherical CB and brittle clay platelet, which may lead us to explain the mechanism of advanced percolation phenomenon discussed in previously. Bright-field TEM images of various Ny6/CB compositions with 20 phr CB concentration and varying organoclay-loading are shown in FIGS. 10a-b, where the dark spherical areas represent the primary CB aggregate and the gray/white areas represent the Ny6 matrix. One should be noticed that left is the original and right is the enhanced of divided single TEM image. The arrow indicates the primary organoclay platelet (or the dark single layer). Two distinguished morphological features were observed:

CB/organoclay behave as one “nano-unit” in the Ny6 matrix, which is in the feasible range of communion between two different elastic properties, geometry, and structure of nanoparticles (rigid spherical CB and brittle clay platelet) regardless various organoclay-loading. This fascinating “nano-unit” morphology suggests that there are strong preferred intermolecular interactions between organoclay/nylon 6/CB under zero-shear viscous flow; and

As shown in FIG. 9, the brittle primary organoclay platelet essentially deforms to wrap partially around the rigid primary rock-like CB aggregate according to its geometry. The observed morphology indicates that the deformed single organoclay platelet, which ought to be brittle, has a certain tolerance range of flexibility to be bent and/or deformed; however, it does not require direct contact with CB only close enough in the order of 1.07-1.42 nm range separated by the interphase thickness of Ny6-organic modifier. The thickness of the primary organoclay platelet is 0.7 nm and the length of the platelet is in the 200-300 nm range. The diameter of the primary CB particle is roughly 60 nm. These are close to the reported values such as 1.0 nm for the thickness and 200 nm for the length of the primary clay platelet and 62 nm for the diameter of the primary CB particle morphologies, respectively.

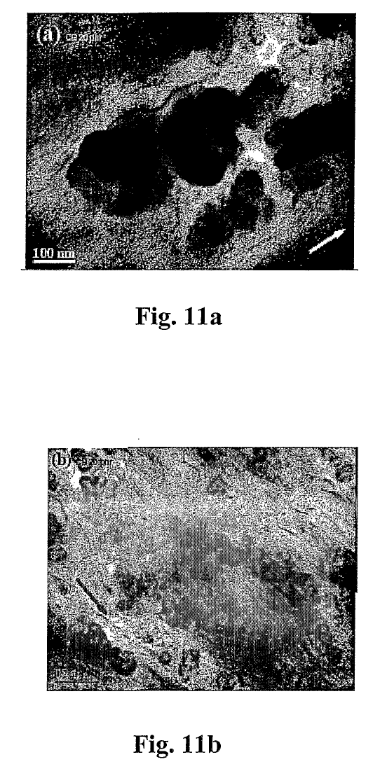

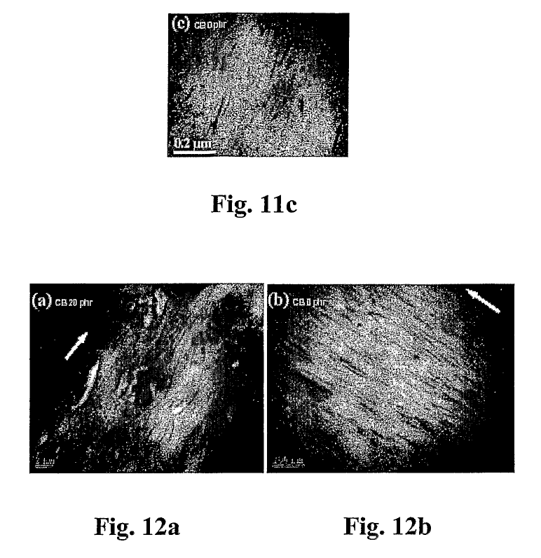

To investigate the effect of shear viscous flow at various thermal history and shearing field upon the “nano-unit” morphology of CB/organoclay behavior, the isotropic molded disks of various Ny6 systems were also subjected to isothermal shearing by using rheometry. Raw materials were subjected to non-isothermal mixing by using twin screw extruder. FIG. 11 shows TEM images of sheared parts (ω=50 rad/s at 230° C. for 200 sec) and FIG. 12 shows TEM images of extruded parts (screw speed 200 rpm at 230° C.), where the dark spherical areas represent the primary CB aggregate, the dark layers represent the primary organoclay platelet, and the gray/white areas represent the Ny6 matrix (all images are enhanced). The shearing direction is indicated by the arrow. The organoclay dispersion in both sheared and extruded Ny6 nanocomposites with 5 vol % organoclay-loading (FIGS. 10c and 11b) shows nano-scale organoclay orientation along the shearing directions, unlike the organoclay dispersion in FIG. 9a of nylon 6 nanocomposites, which shows disorder orientation. The geometry of oriented primary organoclay platelet shows more enhanced linear arrangement along the shearing direction, which is artificial re-alignment of pristine clay platelet geometry induced by mechanical shear. The presence of CB network in Ny6 nanocomposites seems to orient under shear flow; however, it disorients the organoclay dispersion. Although there is a high disorientation caused by the presence of CB, the primary organoclay platelet still persists to orient within CB free channels (FIGS. 11b and 12a). The highlight comprised FIG. 10a is that the brittle primary organoclay platelet essentially deforms to wrap partially around the rigid primary CB aggregate according to its geometry, resulting again in this particular “nano-unit” morphology of CB/organoclay behavior even under shearing fields. This observation supports the observations made from FIG. 9 and this morphological data reflects the strength of interfacial bonding between organoclay/Ny6/CB via preferred intermolecular interactions with novel features on the flexibility of primary clay platelet.

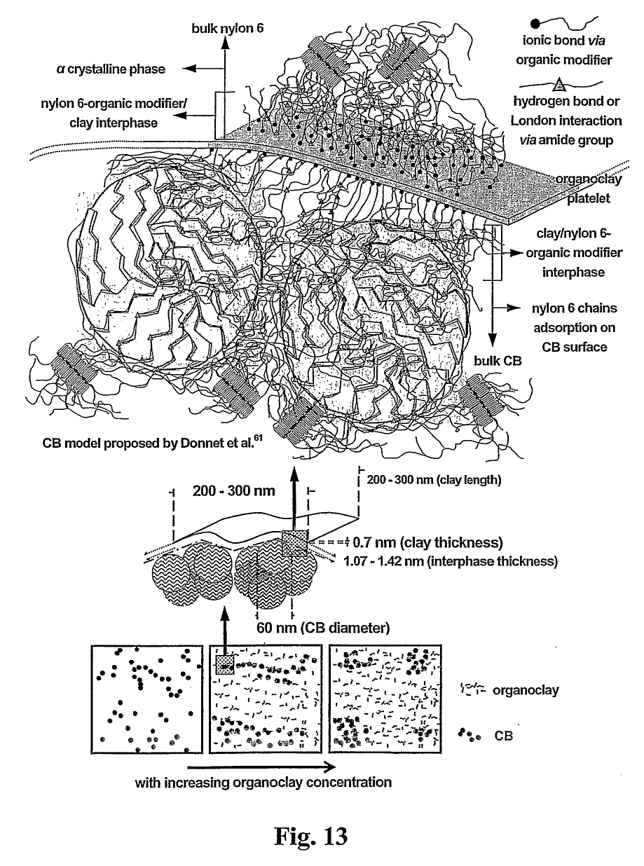

In sum, FIG. 13 shows the mechanism that we believe advanced percolation to the thermodynamic intermolecular physical/chemical interactions between organoclay/Ny6/CB. Without the presence of organoclay, the state of CB dispersion is in random distribution, which is uncontrollable. By 3 vol % organoclay loading, CB is forced to construct conducting network, resulting early percolation despite below the percolation threshold of original Ny6/CB system. Further increasing of organoclay brings “stability” and/or regular distribution in the state of CB dispersion, which able to control the electrical conductivity. Although it was found that clarifying the types of interactions in multi-phase polymeric materials are to be a very difficult task, if not impossible, since each component in organoclay/Ny6/CB has very reactive sites and polar functional groups, the types of interactions were attributed to the combination of weak physical interactions (dipole-induced dipole) and strong chemical interactions (hydrogen bonding).

We claim:

1. A polymeric composition comprising:
a polymeric resin;
a conductive filler; and
a dispersion-control agent that promotes generally-uniform arrangement of the conductive filler throughout the polymeric composition, wherein
said polymeric composition is substantially devoid of polycyclic aromatic compounds.

2. The polymeric composition of claim 1, wherein the polymeric network comprises a thermoplastic polymer.

3. The polymeric composition of claim 1, wherein the polymeric network comprises a thermosetting polymer.

4. The polymeric composition of claim 1, wherein the polymeric network comprises a polymer selected from the group consisting of Polyamides, Polyesters, and Polyolefins.

5. The polymeric composition of claim 1 wherein the conductive filler is selected from the group consisting of carbon black, conductive carbon black, and a carbon nanotube.

6. A polymeric composition comprising:
a polymeric resin;
a conductive filler; and
an effective amount of a non-conducting filler to increase the electrical conductivity of the polymeric composition relative to the same composition without the addition of sub micron to nano sized particles, wherein
the polymeric composition is substantially devoid of polycyclic aromatic compounds.

7. The polymeric composition of claim 6, wherein the conductive filler is selected from the group consisting of carbon black, conductive carbon black, and a carbon nanotube.

8. The polymeric composition of claim 6, wherein the non-conducting filler is a particulate filler having a sub-micron or nanometer particle size.

9. The polymeric composition of claim 6, wherein the polymeric composition has a percolation threshold that is lower than a percolation threshold of the same polymeric composition without the non-conducting filler.

10. A polymeric composition comprising:
a polymeric resin;
a conductive filler; and
an effective amount of sub-micron to nano-sized non-conducting particles to lower the percolation threshold relative to the percolation threshold of the same polymeric composition without the sub-micron to nano-sized non-conducting particles, wherein
the polymeric composition is substantially devoid of polycyclic aromatic compounds.

11. A polymeric composition comprising:
a polymeric resin;
a conductive filler; and
an effective amount of a dispersion-control agent to minimize the sensitivity of electrical conductivity of the polymeric composition to changes in a concentration of the conductive filler in a desired region of electrical conductivity, wherein
the polymeric composition is substantially devoid of polycyclic aromatic compounds.

12. A method for controlling the electrical conductivity of a polymeric composition, the method comprising the steps of:
identifying a desired range of electrical conductivity, said range including a target electrical conductivity therein;
introducing an effective amount of a dispersion-control agent to a polymeric resin to minimize the sensitivity of the electrical conductivity of the polymeric composition within the desired region of electrical conductivity; and
introducing a conductive filler to the polymeric resin to provide the polymeric composition with the target electrical conductivity.
